(19) United States
(12) Patent Application Publication
(10) Pub. No.: US 2022/0357257 A1
(43) Pub. Date: Nov. 10, 2022

(54) METHOD FOR CALCULATING A QUALITY OF A MEASURING TUBE OF A CORIOLIS MEASURING DEVICE AND SUCH A MEASURING DEVICE

(71) Applicant: Endress+Hauser Flowtec AG, Reinach (CH)

(72) Inventors: Alfred Rieder, Landshut (DE); Martin Josef Anklin, Dornach (CH); Severin Ramseyer, Münchenstein (CH); Benjamin Schwenter, Breitenbach (CH); Marco Oliver Scherrer, Muttenz (CH); Johan Pohl, Freiburg (DE); Dirk Butzbach, Huningue (FR)

(21) Appl. No.: 17/634,460

(22) PCT Filed: Jul. 10, 2020
(86) PCT No.: PCT/EP2020/069526

§ 371 Date: Feb. 10, 2022

(30) Foreign Application Priority Data
Aug. 16, 2019 (DE) 10 2019 122 094.7

(51) Int. Cl. G01N 9/32; G01F 1/84; G01F 15/02

(52) U.S. Cl. CPC G01N 9/32; G01F 1/8477; G01F 1/8427; G01F 1/8422; G01F 1/8431; G01F 15/02

(57) ABSTRACT

The present disclosure relates to a method for calculating a quality pertaining to at least one measuring tube of a Coriolis measuring device for measuring a density or a mass flow of a medium flowing through the measuring tube, wherein a determination regarding a state of the measuring tube can be made by determining various vibration properties.

The invention relates to a method for calculating a quality of a measuring tube of a Coriolis measuring device with respect to wear or coating formation and to such a measuring device.

WO2010127951A1 discloses a method and Coriolis measuring device with which a current vibration property of a measuring tube is back-calculated into a standard vibration property, and a current wall thickness of the measuring tube is determined therefrom. In this way, wear of the measuring tube can be detected, for example. The back-calculation requires various influences to be taken into account. It is known in the prior art that the following variables are relevant: medium temperature, support member temperature, housing temperature and also a medium density. This document also provides the person skilled in the art with basic physical knowledge in regard to the vibration theory of measuring tubes of Coriolis measuring devices.

However, it has been found that a back-calculation according to the prior art only insufficiently satisfies high demands and in particular wear can only be detected late and would preferably be determined qualitatively.

The object of the invention is therefore to determine a measuring tube quality in such a way that this determination satisfies even high demands.

The object is achieved by a method according to independent claim 1 and by a Coriolis measuring device according to independent claim 13.

In a method according to the invention for calculating a quality relating to at least one measuring tube of a Coriolis measuring device for measuring a density or a mass flow rate of a medium flowing through the measuring tube, wherein the Coriolis measuring device comprises the following:

a vibration system having at least one measuring tube for conducting the medium,

at least one exciter designed to excite measuring tube vibrations and at least two sensors to detect the measuring tube vibrations, the exciter and/or the sensors each having at least one

magnet device and one coil device,

a support member for supporting the at least one measuring tube,

an electronic measurement/control circuit designed to operate the exciter and designed to provide measured values of the density and/or mass flow, and to carry out the method,

an electronics housing in which the electronic measurement/control circuit is arranged,

the method has at least the following steps:

relating at least one excitation input variable of the at least one exciter to at least one output variable of at least one sensor,

determining a current vibration property of the vibratory system on the basis of a vibration model of the measuring tube and the relationship,

determining from the current vibration property of the vibration system a standard vibration property of the measuring tube under standard conditions,

wherein, in at least one of the method steps, at least one of the following variables is used:

a non-linear contribution of at least one of the following temperatures: medium temperature, support member temperature, housing temperature;

a medium pressure;

at least one accumulated time over which the magnet device is exposed to a temperature above a respective threshold temperature;

a medium viscosity.

By determining the standard vibration property according to the invention, it is possible to determine the standard vibration property of a measuring tube much more accurately, since subtle interfering influences are now corrected.

An increased medium pressure, for example, causes an increased measuring tube diameter so that a measuring tube stiffness is changed. If the medium pressure is not taken into account, a determination of the standard vibration properties will be incorrect.

It has been found that taking into account temperatures according to the prior art is not satisfactory.

Permanent magnets of magnet devices are susceptible to elevated temperatures, which can cause or accelerate a reduction in magnetization of the permanent magnets. This susceptibility can increase greatly above a threshold temperature, such threshold temperatures being highly material-dependent. Several threshold temperatures above which aging increases can also exist. The person skilled in the art is able to determine such threshold temperatures of a permanent magnet. If a permanent magnet of a sensor or exciter is impaired by elevated temperatures, in the case of an exciter an excitation current will produce a smaller excitation magnetic field, which results in a smaller measuring tube vibration amplitude. In the case of a sensor, such impairment results in a lower voltage induction of a measurement voltage. If temperature-related or aging-related impairments of permanent magnets are not taken into account, a determination of the standard vibration properties will be incorrect.

In one embodiment, a first set of temperature coefficients or a second set of temperature coefficients is used when using the medium temperature and/or the support member temperature and/or the housing temperature,

wherein the first set of temperature coefficients is used if the medium temperature is higher than a limit temperature,

wherein the second set of temperature coefficients is used if the medium temperature is lower than the limit temperature.

Vibration properties of the measuring tube are influenced by material properties, such as the modulus of elasticity, or thermal expansion coefficients of the measuring tube and/or of the support member and/or of the housing. The support member and/or the housing can influence the measuring tube via bearing points, for example via clamping forces. These material properties, for example, the modulus of elasticity, are temperature-dependent, so that in precise measuring devices, such as a Coriolis measuring device, such temperature dependencies must be taken into account. Typically this is done by means of mathematical models in which, for example, polynomial functions with corresponding coefficients up to an n-th order are applied, where n is a natural number. As n increases the determination of coefficients becomes more difficult and more inaccurate. According to the invention, an operating temperature range in which a Coriolis measuring device is to be used is therefore divided into at least two ranges, each separated by a limit temperature, and a model of a somewhat lower order with its own coefficients is respectively used in these ranges. In this way, the effort for determining higher-order coefficients can be limited.

Such a limit temperature can be set, for example, between −50° C. and +50° C., e.g., even, for example, at 0° C. However, this information is to be interpreted purely as an example and not as limiting.

This procedure is not limited to the use of polynomial functions. A person skilled in the art is able to select at least one function family according to his requirements in order to create a mathematical model.

Neither is this procedure limited to dividing the operating temperature range into two ranges separated by a limit temperature. The operating temperature range can also be divided into more than two ranges, wherein adjacent ranges are in each case separated by a limit temperature.

In one embodiment, at least one of the following variables is additionally used to calculate the standard vibration property:

at least one of the following temperatures: medium temperature, support member temperature, housing temperature, exciter temperature, sensor temperature;

medium density and/or a square of the medium density.

Each of the listed temperatures potentially influences a measurement of a vibration property of the measuring tube. Housing temperature or support member temperature affect clamping or fastening of the measuring tube; exciter temperature or sensor temperature, for example, affect an ohmic resistance of a coil system and thus an efficiency of excitation or detection of measuring tube vibrations.

The medium density influences the total mass of the vibration system and thus a resonance frequency of the vibration system.

In one embodiment, at least a first accumulated time is measured with respect to a first threshold temperature, and a second accumulated time is measured with respect to a second threshold temperature and used to calculate the standard vibration property. It is not excluded in this case that further threshold temperatures and further accumulated times are used. Materials that can be used as permanent magnets can, for example, have multiple threshold temperatures at which an exceeding, an aging or impairment of the permanent magnet proceeds more quickly, for example. The threshold temperatures are here material-dependent. A person skilled in the art will therefore specifically inform himself about such threshold temperatures or determine them, for example, via tests.

In one embodiment, the at least one accumulated time is an argument of a non-linear, monotonic, and in particular degressive function, wherein the function can be described, for example, by means of a logarithm function or a root function or an exponential function.

In one embodiment, the medium temperature and/or the support member temperature and/or the housing temperature are each determined by at least one temperature sensor provided for this purpose.

In one embodiment, moduli of elasticity of the measuring tube or of the support member or of a housing wall of the electronics housing are used to determine the temperature coefficients of a set of temperature coefficients.

In one embodiment, the non-linear contribution is, for example, a quadratic, logarithmic, potential or exponential contribution.

In one embodiment, the method comprises the following method step:

comparing the standard vibration property with a reference vibration property, which reference vibration property is determined, for example, by a factory calibration or an operating calibration under standard conditions.

In one embodiment, the method comprises the following method step:

observing a temporal development of the standard vibration property,

outputting a warning message if:

the standard vibration property has a minimum deviation from the reference vibration property,

and/or a value of a rate of change of the standard vibration property exceeds a minimum value.

In one embodiment, the vibration property is a modal stiffness.

In one embodiment, the vibration model is formed with a degree of freedom, which is applied up to the second order,

in particular that the vibration model has the component

$$\frac{{F}_{D}}{{X}_{S}} = ah \vert 1 + \frac{s}{{ω}_{0} Q} + \frac{{s}^{2}}{{ω}_{0}^{2}} \vert ,$$

where

F_{D} is an excitation force exerted by the at least one exciter on the at least one measuring tube and forming the excitation input variable,

X_{S} is an amplitude of the vibrations of the vibration system caused by the exciter, which amplitude forms a response variable which correlates with the output variable AG of the sensor, wherein the correlation possibly depend on a state such as, for example, an aging state of a permanent magnet,

a is a material-dependent and geometry-dependent constant of the at least one measuring tube,

h is the tube wall thickness of the at least one measuring tube,

ω₀ is a resonance frequency of the respectively excited vibration mode,

Q is a quality factor which describes the decay behavior of the vibrations of the vibration system during a single excitation, and

s=i ω, where ω corresponds to an excitation frequency of the vibration system, and

wherein the product of a and h is a measure of the modal stiffness of the at least one measuring tube.

A Coriolis measuring device according to the invention designed to carry out the method according to any one of the preceding claims comprises:

a vibration system having at least one measuring tube for conducting the medium,

at least one exciter designed to excite measuring tube vibrations and at least two sensors to detect the measuring tube vibrations, the exciter and/or the sensors each having at least one magnet device with a permanent magnet and one coil device,

a support member for supporting the at least one measuring tube,

an electronic measurement/control circuit designed to operate the exciter and designed to provide measured values of the density and/or mass flow, and to carry out the method,

an electronics housing in which the electronic measurement/control circuit is arranged.

In one embodiment, the Coriolis measuring device has at least one temperature sensor designed to measure at least one of the following temperatures:

medium temperature, support member temperature, housing temperature, exciter temperature, sensor temperature.

The invention will now be described with reference to exemplary embodiments.

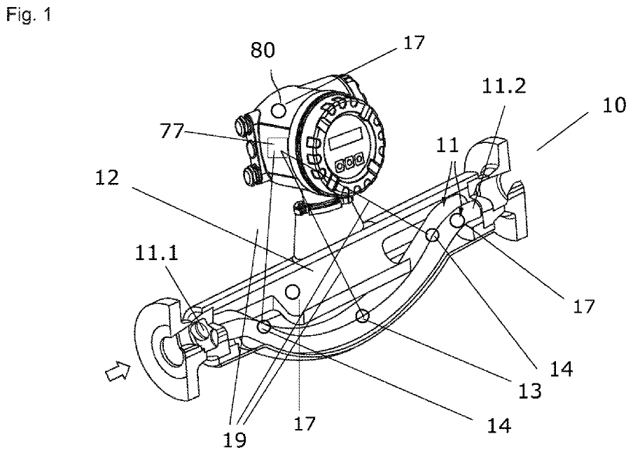

FIG. 1 describes a structure of an exemplary Coriolis measuring device with an exemplary Coriolis measuring transducer;

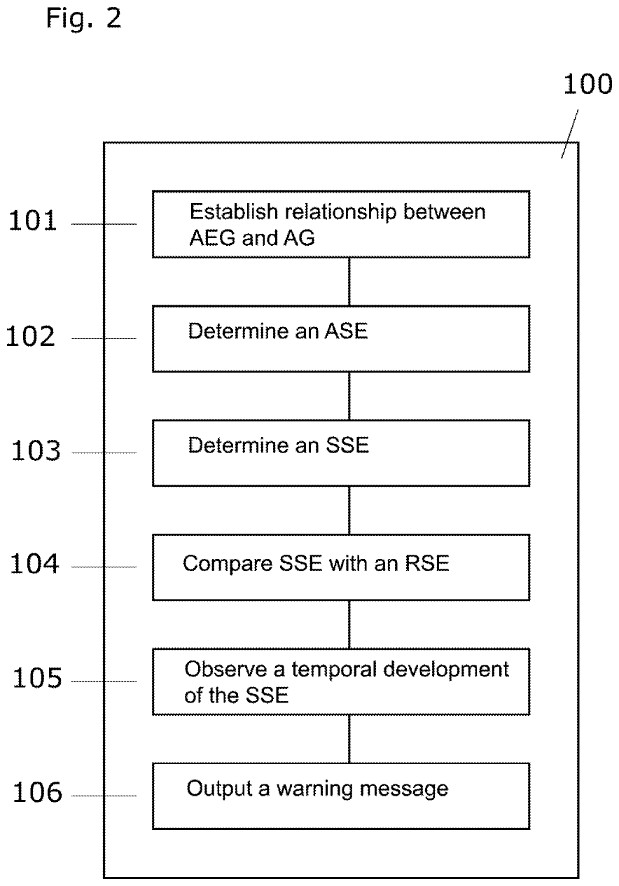

FIG. 2 describes the sequence of a method according to the invention;

FIG. 1 illustrates the structure of an exemplary Coriolis measuring device 10 according to the invention with an exemplary Coriolis measuring transducer according to the invention, the Coriolis measuring transducer having a vibration system with two measuring tubes 11 each having an inlet and an outlet, a support member 12 for supporting the measuring tubes, an exciter 13, and two sensors 14. The exciter is designed to excite the two measurement tubes to vibrate perpendicular to a longitudinal measurement tube plane defined by the arcuate measurement tubes. The sensors are designed to detect the vibration impressed upon the measurement tubes. Temperature sensors 17 are designed to detect temperatures of the support member, of the measuring tubes (influenced by a medium temperature), and of the support member. The sensors and the exciter can also be equipped with such temperature sensors. The Coriolis measuring transducer is connected to an electronic housing 80 of the Coriolis measuring device which is designed to house an electronic measurement/control circuit 77, which measurement/control circuit is designed to operate the exciter and the sensors and to determine and provide flow rate values and/or density values on the basis of vibration properties of the measuring tube as measured by means of the sensors. The exciter and the sensors are connected to the electronic measurement/control circuit by means of electrical connections 19. The electrical connections 19 can in each case be bundled by means of cable guides.

A Coriolis measuring instrument according to the invention is not limited to the presence of two measurement tubes. The invention can thus be implemented in a Coriolis measuring device having any number of measuring tubes, for example also in a single-tube or four-tube measuring device.

Unlike what is shown here, the measuring tubes can also be straight and, for example, designed to perform lateral or torsional vibrations.

A number of effects must be taken into account when operating such a Coriolis measuring device. An exciter efficiency accordingly influences a vibration amplitude of the measuring tube, and a sensitivity of the sensors influences an ability to convert a vibration of the measuring tube into a measurement variable, such as a measurement voltage or a measurement current. A Coriolis measuring device is often calibrated under standard conditions before start-up, for example, at a customer of a manufacturer of Coriolis measuring devices, and among other things a relationship between an excitation of measuring tube vibrations by the exciter and a detection of the measuring tube vibrations by the sensors is thus documented. The exciter efficiency as well as the sensor sensitivity are subject to influences which on the one hand can cause reversible changes but also irreversible changes in these variables.

An example of a reversible influence is an increase in an ohmic resistance of a coil device of a sensor due to an increase in the temperature of the coil device, which results in a reduced induction of an electrical voltage by a sensor magnet moved relative to the coil device. An example of a non-reversible change is an aging of the sensor magnet, for example, due to intense heating. Depending on the actual design of a sensor (there are also, for example, optical sensors) or exciter, corresponding similar effects can come to bear.

An adapted method for operating the Coriolis measuring device is thus necessary for accurate measurements of mass flow and/or density and for monitoring of aging or condition.

FIG. 2 describes the sequence of an exemplary method according to the invention for calculating a quality relating to at least one measuring tube 11.1 of a Coriolis measuring device.

In a first method step 101, at least one excitation input variable AEG of the at least one exciter is related to at least one output variable AG of at least one sensor, and

in a second method step 102, a current vibration property ASE of the at least one measuring tube is determined on the basis of a vibration model of the measuring tube and the relationship.

In a third method step 103, a standard vibration property SSE of the measuring tube under standard conditions is determined from the current vibration property of the measuring tube.

In at least one of the method steps, at least one of the following variables is used:

a non-linear contribution of at least one of the following temperatures: medium temperature, support member temperature, housing temperature;

a medium pressure;

at least one accumulated time over which the magnet device is exposed to a temperature above a respective threshold temperature;

a medium viscosity.

By determining the standard vibration property according to the invention, it is possible to determine the standard vibration property of a measuring tube much more accurately, since subtle interfering influences are now corrected.

As shown in FIG. 2, the method can have further method steps.

The method shown here thus comprises the following method steps:

comparing the standard vibration property with a reference vibration property in a fourth method step 104, which reference vibration property RSE is determined, for example, by a factory calibration or an operating calibration under standard conditions.

observing a temporal development of the standard vibration property in a fifth method step 105,

outputting a warning message in a sixth method step 106 if:

the standard vibration property SSE has a minimum deviation from the reference vibration property RSE,

and/or a value of a rate of change of the standard vibration property exceeds a minimum value.

In this way, the customer of a manufacturer of such Coriolis measuring devices and/or the manufacturer can be notified of a lack of reliability or a poor measuring tube condition of measuring tubes of the Coriolis measuring device, for example due to abrasion or coating formation, and timely replacement or cleaning can be ensured.

A standard vibration property SSE can thus be represented in an abstract manner, for example by the following equation:

SSE=ASE*K_temp*K_density*K_pressure*K_aging*K_visc,

wherein constant, linear and non-linear influences can be used in the correction terms K as described above. The person skilled in the art is able to quantify these influences in a Coriolis measuring device and to determine corresponding coefficients for these influences.

The correction term K_temp can, for example, be defined as follows:

K_temp=C1+K1*T_med+K2*(T_med)^2 with T_med as medium temperature, C1 as a constant, K1 a first coefficient and K2 a second coefficient. The same applies to the correction terms with respect to the support member temperature or the housing temperature. The non-linear term here is quadratic, by way of example, but can have any other desired form of non-linearity and can thus be, for example, a logarithmic, potential, or exponential contribution.

In a similar manner, the correction terms can be formulated with their own coefficients with regard to the variables of density, pressure, viscosity and aging of the permanent magnets. With the aging of the permanent magnets, a logarithm or a root function or an exponential function can be used as degressive function for the purpose of describing the aging, for example, wherein the at least one accumulated time over which the magnet device is exposed to a temperature above a respective threshold temperature is included in the function as an argument in each case. An example of a description of the aging with a function having an exponential function is the following term: C2−K3*exp(−x*K4+K5) with x as a variable for the accumulated time, C2 as a constant and K3 to K5 as coefficients.

The description of a relationship between SSE and ASE presented here is to be interpreted purely as an example and not limiting.

### LIST OF REFERENCE SIGNS

10 Coriolis measuring device

11 Vibration system

11.1 Measuring tube

12 Support member

13 Exciter

14 Sensor

15 Magnet device

16 Coil device

17 Temperature sensor

19 Electrical connection

77 Electronic measurement/control circuit

80 Electronics housing

100 Method

101-106 Method steps

AEG Excitation input variable

AG Output variable

ASE Current vibration property

SSE Standard vibration property

RSE Reference vibration property

1-14. (canceled)

15. A method for calculating a quality relating to at least one measuring tube of a Coriolis measuring device configured for measuring a density or a mass flow rate of a medium flowing therethrough, wherein the Coriolis measuring device comprises:
a vibration system including at least one measuring tube configured to conduct the medium therethrough;
at least one exciter configured to excite measuring tube vibrations in the at least one measuring tube;
at least two vibration sensors configured to detect the measuring tube vibrations, wherein the at least one exciter and/or the at least two vibration sensors each include at least one magnet device, including a permanent magnet and one coil device;
a support member configured to support the at least one measuring tube;
an electronic measurement/control circuit configured to operate the at least one exciter, to generate measured values of the density and/or mass flow rate of the medium, and to perform operations of the method; and
an electronics housing in which the electronic measurement/control circuit is disposed, the method comprising the following steps:
relating at least one excitation input variable of the at least one exciter to at least one output variable of at least one vibration sensor;
determining a current vibration property of the vibration system based on a vibration model of the at least one measuring tube and the relationship of the at least one excitation input variable to at least one output variable;
determining a standard vibration property of the at least one measuring tube under standard conditions from the current vibration property of the vibration system, wherein at least one of the following variables is used in at least one of the method steps:
a non-linear contribution of at least one of the following temperatures: medium temperature, support member temperature and housing temperature;
a medium pressure;
at least one accumulated time over which at least one of the magnet devices is exposed to a temperature above a respective threshold temperature; and
a medium viscosity.

16. The method of claim 15, wherein a first set of temperature coefficients or a second set of temperature coefficients is used when using at least one of the medium temperature, the support member temperature and/or the housing temperature,
wherein the first set of temperature coefficients is used when the medium temperature is higher than a limit temperature,
wherein the second set of temperature coefficients is used when the medium temperature is lower than the limit temperature.

17. The method of claim 15, wherein at least one of the following variables is additionally used to determine the standard vibration property:
at least one of the following temperatures: medium temperature, support member temperature, housing temperature, exciter temperature and vibration sensor temperature; and
a medium density and/or a square of the medium density.

18. The method of claim 15, wherein the at least one accumulated time includes a first accumulated time, measured with respect to a first threshold temperature, and a second accumulated time, measured with respect to a second threshold temperature, and
wherein the first accumulated time and the second accumulated time are used to calculate the standard vibration property.

19. The method of claim 15, wherein the at least one accumulated time is an argument of a non-linear, monotonic degressive function, wherein the degressive function is a logarithm function, a root function or an exponential function.

20. The method of claim 15, wherein at least one of the medium temperature, the support member temperature, and/or the housing temperature are each determined by at least one temperature sensor adapted and arranged accordingly.

21. The method of claim 16, wherein moduli of elasticity of the at least one measuring tube, the support member or a housing wall of the electronics housing are used to determine the temperature coefficients of the first set of temperature coefficients or the second set of temperature coefficients.

22. The method of claim 15, wherein the non-linear contribution is, a quadratic, logarithmic, potential or exponential contribution.

23. The method of claim 15, further comprising:
comparing the standard vibration property with a reference vibration property, which reference vibration property is determined by a factory calibration or an operating calibration under standard conditions.

24. The method of claim 15, further comprising:
observing a temporal development of the standard vibration property; and
outputting a warning message when:
the standard vibration property has a minimum deviation from the reference vibration property; and/or
a value of a rate of change of the standard vibration property exceeds a minimum value.

25. The method of claim 15, wherein the standard vibration property is a modal stiffness.

26. The method of claim 25, wherein the vibration model includes with a degree of freedom that is applied up to a second order, wherein the vibration model includes the following component:
$$\frac{{F}_{D}}{{X}_{S}} = ah \vert 1 + \frac{s}{{ω}_{0} Q} + \frac{{s}^{2}}{{ω}_{0}^{2}} \vert ,$$
where F_{D} is an excitation force exerted by the at least one exciter on the at least one measuring tube and defining the excitation input variable, X_{S} is an amplitude of the vibrations of the vibration system caused by the at least one exciter, which amplitude defines a response variable, a is a material-dependent and geometry-dependent constant of the at least one measuring tube, h is a tube wall thickness of the at least one measuring tube, ω₀ is a resonance frequency of a respectively excited vibration mode, Q is a quality factor that describes a decay behavior of the vibrations of the vibration system during a single excitation, and s=i ω, where ω corresponds to an excitation frequency of the vibration system, and
wherein the product of a and h is a measure of the modal stiffness of the at least one measuring tube.

27. A Coriolis measuring device for measuring a density or a mass flow rate of a medium flowing therethrough, the measuring device comprising:
a vibration system including at least one measuring tube configured to conduct the medium therethrough;
at least one exciter configured to excite measuring tube vibrations in the at least one measuring tube; and
at least two vibration sensors configured to detect the measuring tube vibrations, wherein the at least one exciter and/or the at least two vibration sensors each include at least one magnet device, including a permanent magnet and one coil device;
a support member configured to support the at least one measuring tube;
an electronic measurement/control circuit configured to operate the at least one exciter, to generate measured values of the density and/or mass flow rate of the medium, and to perform operations of the method according to claim 15; and
an electronics housing in which the electronic measurement/control circuit is disposed.

28. The measuring device of claim 27, further comprising at least one temperature sensor configured to measure at least one of the following temperatures: medium temperature, support member temperature, housing temperature, exciter temperature and vibration sensor temperature.
